(19) United States
(12) Patent Application Publication
(10) Pub. No.: US 2017/0288915 A1
(43) Pub. Date: Oct. 5, 2017

(54) Systems and Methods for Mitigating Over-Equalization in a Short Channel

(71) Applicant: Avago Technologies General IP (Singapore) Pte. Ltd, SINGAPORE (SG)

(72) Inventors: Nayak Ratnakar Aravind, Allentown, PA (US); Mohammad Mobin, Orefield, PA (US); Thomas Gibbons, Macungie, PA (US)

(21) Appl. No.: 15/088,872

(22) Filed: Apr. 1, 2016

(51) Int. Cl. H04L 25/03; H04L 27/00; H04L 7/00

(52) U.S. Cl. CPC H04L 25/03057; H04L 7/0087; H04L 25/03343; H04L 27/0002; H04L 2025/03681; H04L 2025/0349

(57) ABSTRACT

Embodiments are related to systems and methods for data processing, and more particularly to systems and methods for clock recovery in a data receiver.

### FIELD OF THE INVENTION

Embodiments are related to systems and methods for data processing, and more particularly to systems and methods for serial data transfer.

### BACKGROUND

A number of data transfer systems have been developed. Some transfer systems transfer clocked data without a clock. In such systems, the clock is recovered from the transferred data. In some cases, serial data is received from a transmitting device and processed to recover the originally transmitted data. This processing can include, for example, amplification and equalization. In some cases the amplification and equalization is not done well resulting in a less than optimal data recovery.

Hence, for at least the aforementioned reasons, there exists a need in the art for advanced systems and methods for processing received data.

### BRIEF DESCRIPTION OF THE FIGURES

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a serial data transfer system including a serial data receiver having over-equalization mitigation circuitry in accordance with various embodiments of the present inventions;

FIG. 2 shows a serial data receiver including over-equalization mitigation circuitry in accordance with some embodiments of the present invention; and

FIG. 3 is a flow diagram showing a method in accordance with some embodiments of the present invention for mitigating over-equalization in a data transfer system.

### DETAILED DESCRIPTION OF SOME EMBODIMENTS

Embodiments are related to systems and methods for data processing, and more particularly to systems and methods for serial data transfer.

Various embodiments of the present inventions provide data transfer systems that include a receiver circuit. The receiver circuit is operable to recover a data input from a data transfer set to yield a data output. The receiver circuit includes a gain and equalization adaptation circuit and an over-equalization mitigation constraint circuit. The gain and equalization adaptation circuit is operable to adaptively calculate an equalizer coefficient and a gain control. The over-equalization mitigation constraint circuit is operable to increment the gain control to yield an updated gain control based at least in part on the equalizer coefficient.

In some instances of the aforementioned embodiments, the system further includes a transmission circuit operable to prepare the data input for transmission to the receiver circuit. In some such instances, the receiver circuit further includes a serial data recovery circuit having an equalizer circuit operable to equalize an input set derived from the data transfer set to yield the data input. Operation of the equalizer circuit is governed at least in part based upon the equalizer coefficient. In various cases, the receiver circuit further includes an analog front end circuit having a variable gain amplifier that is operable to amplify an analog signal derived from the data transfer set to yield an amplified output. Operation of the variable gain amplifier is governed at least in part based upon the gain control. In such cases, the input set is derived from the amplified output.

In various instances of the aforementioned embodiments, the over-equalization mitigation constraint circuit is operable to increment the gain control to yield an updated gain control when at least the equalization coefficient is a minimum allowable value. In some cases, the over-equalization mitigation constraint circuit is operable to increment the gain control to yield an updated gain control when the equalization coefficient is the minimum allowable value and the gain control is not a maximum allowable value. In one or more instances of the aforementioned embodiments, the over-equalization mitigation constraint circuit includes a comparator operable to compare the equalizer coefficient with a coefficient threshold to yield a coefficient status, and wherein the gain control is incremented based at least in part on the coefficient status. In some such instances, the comparator is a first comparator, and the over-equalization mitigation constraint circuit further includes a second comparator operable to compare the gain control with a gain threshold to yield a gain status, and wherein the gain control is incremented based upon a combination of the coefficient status and the gain status. In some instances of the aforementioned embodiments, the gain control is a low frequency gain target, and the receiver circuit further includes a back channel feedback circuit operable to generate a back channel feedback data set based at least in part on one or both of the equalizer coefficient and the low frequency gain target. In one or more cases, the system further includes a transmission circuit operable to prepare the data input for transmission based at least in part on the back channel feedback data set to yield a data transfer set.

Other embodiments of the present inventions provide methods for data transmission that include: receiving a data transfer set by a receiver circuit; using a variable gain amplifier circuit to amplify a first data input derived from the data transfer set to yield an amplified output, where amplification by the variable gain amplifier circuit is governed at least in part based upon a gain control; using an equalizer circuit to equalize a second data input derived from the first data input to yield an equalized output, where equalization by the equalizer circuit is governed at least in part based upon an equalizer coefficient; and adaptively modifying at least one of the equalizer coefficient and the gain control based at least in part on an error value, where the gain control is incremented when at least the equalizer coefficient is a minimum allowable value.

In some instances of the aforementioned embodiments, adaptively modifying the at least one of the equalizer coefficient and the gain control based at least in part on the error value includes incrementing the gain control when the equalizer coefficient is a minimum allowable value and the gain control is less than a maximum allowable value. In various instances of the aforementioned embodiments, the methods further include preparing the data input in a transmission circuit for transmission to the receiver device via a medium. In some such instances, the methods include: generating a back channel feedback data set in the receiver circuit based at least in part on one or both of the equalizer coefficient and the low frequency gain target; and communicating the back channel feedback data set to the transmission circuit, where preparing the data input for transmission is governed at least in part based upon the back channel feedback data set.

In one or more instances of the aforementioned embodiments, the methods further include comparing the equalizer coefficient with a coefficient threshold to yield a coefficient status. In such cases, the gain control is incremented based at least in part on the coefficient status. In some such instances, the methods further include comparing the gain control with a gain threshold to yield a gain status, where the gain control is incremented based upon a combination of the coefficient status and the gain status. In some cases, the gain control is incremented when the coefficient status indicates that the equalizer coefficient is not greater than the coefficient threshold and the gain status indicates that the gain control is less than the gain threshold.

Yet other embodiments provide storage devices that include a receiver circuit and a transmission circuit. The receiver circuit is operable to recover a data input from a data transfer set to yield a data output. The receiver circuit includes: a gain and equalization adaptation circuit operable to adaptively calculate an equalizer coefficient and a gain control; an over-equalization mitigation constraint circuit operable to increment the gain control to yield an updated gain control based at least in part on the equalizer coefficient; a serial data recovery circuit including an equalizer circuit operable to equalize an input set derived from the data transfer set to yield the data input where operation of the equalizer circuit is governed at least in part based upon the equalizer coefficient. The transmission circuit is operable to prepare the data input for transmission to the receiver circuit.

In some instances of the aforementioned embodiments, the receiver circuit includes an analog front end circuit including a variable gain amplifier operable to amplify an analog signal derived from the data transfer set to yield an amplified output. In such instances, operation of the variable gain amplifier is governed at least in part based upon the gain control, and the input set is derived from the amplified output. In one or more instances of the aforementioned embodiments, the over-equalization mitigation constraint circuit is operable to increment the gain control to yield an updated gain control when the equalization coefficient is the minimum allowable value and the gain control is not a maximum allowable value.

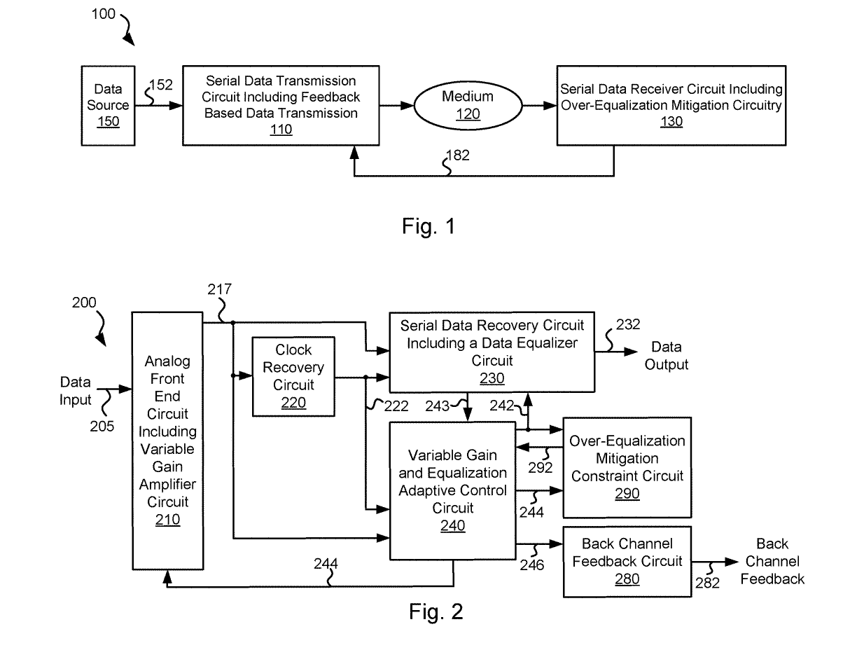

Turning to FIG. 1, a serial data transfer system 100 is shown that includes a serial data transmission circuit 110 and a serial data receiver circuit 130. Serial data transmission circuit 110 may be any circuit known in the art for generating a stream a serial data to be transferred to serial data receiver circuit 130 via a medium 120. Based upon the disclosure provided herein, one of ordinary skill in the art will recognize a variety of data transmission circuitry that may be used in relation to different embodiments of the present invention. Operation of the aforementioned data transmission circuitry is governed at least in part based upon a back channel feedback data set 182 generated by serial data receiver circuit 130. Based upon the disclosure provided herein, one of ordinary skill in the art will recognize one or more signals including, but not limited to, filter coefficients for an finite impulse response filter that may be included in back channel feedback data set 182. Further, based upon the disclosure provided herein, one of ordinary skill in the art will recognize one or more circuits within serial data transmission circuit 110 that may be governed based at least in part on back channel feedback data set 182.

Medium 120 may be, but is not limited to, a wired or wireless transfer medium. Such wired transfer mediums may be a metal wire transfer medium capable of transmitting electrical signal, or may be an optical transfer medium capable of transferring light. Based upon the disclosure provided herein, one of ordinary skill in the art will recognize a variety of wired transfer media that may be used in relation to different embodiments of the present invention. The aforementioned wireless transfer mediums may be an atmosphere capable of transmitting, for example, radio frequency signals. Based upon the disclosure provided herein, one of ordinary skill in the art will recognize a variety of wireless transfer media that may be used in relation to different embodiments of the present invention.

Serial data receiver circuit 130 receives the transmitted serial data via medium 120. The received serial data is sampled and the sampled data is provided to one or more circuits (not shown) for processing. As part of receiving the serial data, a clock is recovered from the received serial data and used to process the incoming serial data. Serial data receiver circuit 130 includes a back channel feedback circuit that calculates back channel feedback data set 182. The back channel feedback circuit may be implemented and operate similar to that discussed in U.S. patent application Ser. No. 14/813,049 entitled “Systems and Methods for Back Channel Adaptation in a Serial Transfer” and filed Jul. 29, 2015 by Ratnakar Aravind et al. The entirety of the aforementioned application is incorporated herein by reference for all purposes. In addition, serial data receiver circuit 130 includes over-equalization mitigation circuitry that operates to adapt a variable gain and an equalizer coefficient in such a way that the possibility of the equalizer coefficient being at an extreme is reduced.

In some cases, serial data transfer system 100 is implemented as part of a storage device including a storage medium and a read/write head assembly disposed in relation to the storage medium. In such cases, data transferred to/from the storage medium is transferred as a serial data stream generated by serial data transfer system 100. Based upon the disclosure provided herein, one of ordinary skill in the art will recognize a variety of devices in which serial data transfer system 100 may be implemented or deployed.

Turning to FIG. 2, a serial data receiver 200 including over-equalization mitigation circuitry is shown in accordance with some embodiments of the present invention. Serial data receiver 200 includes an analog front end circuit 210 that applies analog processing to a data input 205 to yield a processed analog input 217. Analog front end circuit 210 may include, but is not limited to, an analog filter circuit and a variable gain amplifier circuit. Based upon the disclosure provided herein, one of ordinary skill in the art will recognize a variety of circuitry that may be included as part of analog front end circuit 210. The gain applied by the aforementioned variable gain amplifier circuit is governed by a low frequency amplitude target 244. In particular, analog front end circuit 210 adaptively modifies a variable gain of the variable gain amplifier until an amplified output matches the low frequency amplitude target 244. Processed analog input 217 is derived from the aforementioned amplified output. Any circuit for modifying the variable gain based upon an amplitude target may be used in relation to various embodiments of the present invention.

Processed analog input 217 is provided to a clock recovery circuit 220 that is capable of generating a data clock 222 based upon the received input. Clock recovery circuit 220 may be any circuit known in the art that is capable of recovering or generating a clock signal synchronous to a serial data stream. Based upon the disclosure provided herein, one of ordinary skill in the art will recognize a variety of clock recovery circuits that may be used in relation to different embodiments of the present invention.

Processed analog input 217 is also provided to a serial data recovery circuit 230 that is capable of recovering a data output 232 from the received input. Serial data recovery circuit 230 processes data synchronous to data clock 222. Serial data recovery circuit 230 includes an equalizer circuit that equalizes processed analog input 217 to yield an equalized output which is provided as data output 232. Based upon the disclosure provided herein, one of ordinary skill in the art will recognize a variety of circuitry that may be included as part of serial data recovery circuit 230. The equalization applied by the aforementioned equalizer circuit is governed at least in part based upon an equalizer coefficient 242.

A variable gain and equalization adaptive control circuit 240 adaptively modifies equalizer coefficient 242 and low frequency amplitude target 244. Adaptation of equalizer coefficient 242 and low frequency amplitude target 244 may be done using any adaptation approach known in the art for adapting the aforementioned feedback data. In some embodiments, the aforementioned adaptation is done using a least mean squared adaptation algorithm using an error value 243 generated by serial data recovery circuit 230 based upon data output 232 as is known in the art. As each of equalizer coefficient 242 and low frequency amplitude target 244 are modified, the quality of data output 232 is changed resulting in a change in error value 243. As error value 243 is updated, the least mean square adaptation algorithm applied by variable gain and equalization adaptive control circuit 240 calculates updated values for one or both of equalizer coefficient 242 and low frequency amplitude target 244. These one or more updated values are fed back to one or both of analog front end circuit 210 and/or serial data recovery circuit 230.

The combination of equalizer coefficient 242 and low frequency amplitude target 244 are provided to a back channel feedback circuit 280 as a feedback output 246. Back channel feedback circuit 280 generates a back channel feedback data set 282. Any circuit known in the art for generating back channel feedback may be used in relation to different embodiments of the present inventions. Back channel feedback data set 282 is used to adjust equalization coefficients of an upstream serial data transmitter (not shown) based on some parameters that are measured or sensed in serial data receiver 200. For example, where it is determined that the range of the equalization capability in serial data receiver 200 is insufficient back channel feedback data set 282 is modified to increase the amount of equalization applied by the upstream serial data transmitter. As another example, when the channel between the serial data transmitter and serial data receiver 200 adds noise along with inter-symbol interference (ISI), back channel feedback data set 282 may provide control to the serial data transmitter to boost the signal prior to transmission via the channel.

Equalizer coefficient 242 and low frequency amplitude target 244 are provided to an over-equalization mitigation circuit 290 that uses the received inputs to identify a potential over-equalization scenario and to provide a mitigation feedback output 292 indicative of any identified scenario. In particular, over-equalization mitigation circuit 290 includes a first comparator circuit that compares equalizer coefficient 242 with a minimum allowable value for the coefficient, and a second comparator circuit that compares low frequency amplitude target 244 with a maximum allowable value for the target. Where equalizer coefficient 242 is greater than the minimum allowable value for the coefficient, then the adaptation performed by variable gain and equalization adaptive control circuit 240 did not result in forcing equalizer coefficient 242 to the minimum rail. In such a case, the adaptation is unlikely to have resulted in over-equalization and mitigation feedback output 292 is asserted as a logic ‘0’. Where mitigation feedback output 292 is asserted as a logic ‘0’, variable gain and equalization adaptive control circuit 240 does not make any changes to the adaptation process.

Where, on the other hand, equalizer coefficient 242 is not greater than the minimum allowable value for the coefficient, then the adaptation performed by variable gain and equalization adaptive control circuit 240 resulted in forcing equalizer coefficient 242 to the minimum rail. In such a case, the adaptation possibly resulted in over-equalization. In such a case where low frequency amplitude target 244 is less than the maximum allowable value for the target, mitigation feedback output 292 is asserted as a logic ‘1’. Where mitigation feedback output 292 is asserted as a logic ‘1’, variable gain and equalization adaptive control circuit 240 increments the value of low frequency amplitude target 244 and performs the adaptation process again allowing the value of equalizer coefficient 242 to change while maintaining the value of low frequency amplitude target 244. By doing this, the value of equalizer coefficient 242 is moved away from the minimum rail thus reducing the possibility of an over-equalization scenario.

Alternatively, where equalizer coefficient 242 is not greater than the minimum allowable value for the coefficient and low frequency amplitude target 244 is not less than the maximum allowable value for the target, it is possible that an over-equalization scenario exists but there is no room to increment low frequency amplitude target 244 to allow for adaptation of equalizer coefficient 242 away from the minimum rail. In such a scenario, mitigation feedback output 292 is asserted as a logic ‘0’. Again, where mitigation feedback output 292 is asserted as a logic ‘0’, variable gain and equalization adaptive control circuit 240 does not make any changes to the adaptation process.

In operation, data input 205 is received by serial data receiver 200 from a serial data transmission circuit via a medium. Analog processing is applied to data input 205 by analog front end circuit 210. Such analog processing may include, but is not limited to, analog filtering and variable gain amplification. Based upon the disclosure provided herein, one of ordinary skill in the art will recognize a variety of analog processing that may be included as part of the aforementioned analog processing. At a minimum analog front end circuit 210 adaptively modifies a variable gain of the variable gain amplifier until an amplified output matches low frequency amplitude target 244. The resulting processed analog input 217 from the analog processing is derived from the aforementioned amplified output. Any circuit for modifying the variable gain based upon an amplitude target may be used in relation to various embodiments of the present invention. Data clock 222 is generated from processed analog input 217 by clock recovery circuit 220. Clock recovery circuit 220 may be any circuit known in the art that is capable of recovering or generating a clock signal synchronous to a serial data stream. Based upon the disclosure provided herein, one of ordinary skill in the art will recognize a variety of clock recovery circuits that may be used in relation to different embodiments of the present invention.

A serial data recovery process is applied by serial data recovery circuit 230 to processed analog input 217 synchronous to data clock 222 to yield data output 232. The serial data recovery process includes equalization to equalize the received data to yield data output 232. Equalizing the received data is controlled at least in part by equalizer coefficient 242. Based upon the disclosure provided herein, one of ordinary skill in the art will recognize a variety of circuitry that may be included as part of the serial data recovery circuit. The resulting data output 232 is provided to a downstream recipient (not shown).

Back channel feedback data set 282 is generated and provided as a feedback input to the transmission circuit by back channel feedback circuit 280. Any back channel feedback calculation approach known in the art may be used in relation to different embodiments of the present inventions. In some embodiments, the calculation is done using a least mean squared adaptation algorithm using an error value resulting from the serial data recovery process as is known in the art. Back channel feedback data set 282 is the basis for back channel control and as such is generated to control one or more circuits included in an upstream data transmission circuit. Adaptation of backchannel feedback data set 282 is used to adjust equalization coefficients of an upstream serial data transmitter based on some parameters that are measured or sensed in a downstream data receiver. For example, where it is determined that the range of the equalization capability in the data receiver is insufficient, the back channel feedback data set is modified to increase the amount of equalization applied by the upstream serial data transmitter. As another example, when the channel between the serial data transmitter and the serial data receiver adds noise along with inter-symbol interference (ISI), the interim feedback data set may provide control to the serial data transmitter to boost the signal prior to transmission via the channel. Such an approach avoids boosting both signal and noise where the boost is applied in the serial data receiver instead of the upstream serial data transmitter. Such an approach may lead to an increase in signal to noise ratio of signals processed by the serial data receiver.

In addition, equalizer coefficient 242 and low frequency amplitude target 244 are adapted by variable gain and equalization adaptive control circuit 240 based upon error value 243 and mitigation feedback output 292. In general, the adaptation operates to reduce the value of error value 243 except that the adaptation is constrained by mitigation feedback output 292. In particular, the adaptation may be any adaptation process known in the art for modifying a combination of equalizer coefficient 242 and low frequency amplitude target 244 and operates as such when mitigation feedback output 292 is a logic ‘0’. But, when mitigation feedback output 292 is a logic ‘1’, the value of low frequency amplitude target 244 is incremented and the adaptation is performed to modify the value of equalizer coefficient 242 while maintaining low frequency amplitude target 244 fixed at the incremented value.

The assertion level of mitigation feedback output 292 is set by over-equalization mitigation constraint circuit 290. In particular, where it is determined that equalizer coefficient 242 is at the lowest value which the equalizer coefficient is allowed to exhibit, mitigation feedback output 292 is asserted at a logic ‘0’. Where, on the other hand, equalizer coefficient 242 is at a minimum and low frequency amplitude target 244 is at a maximum, mitigation feedback output 292 is asserted at a logic ‘0’. Alternatively, where equalizer coefficient 242 is at a minimum and low frequency amplitude target 244 is not at a maximum, mitigation feedback output 292 is asserted at a logic ‘1’.

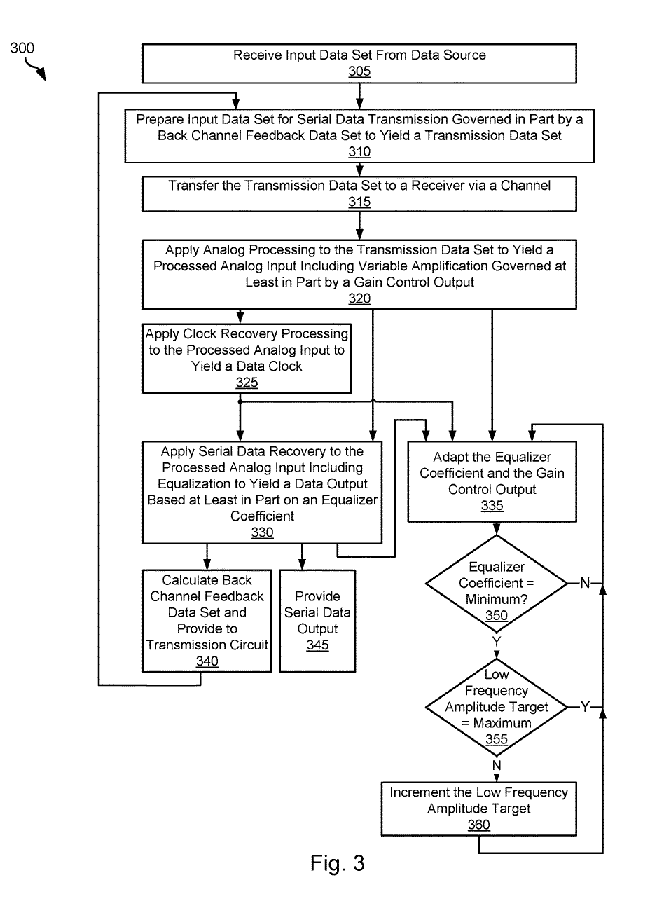

Turning to FIG. 3, a flow diagram 300 shows a method in accordance with some embodiments of the present invention for mitigating over-equalization in a data transfer system. Following flow diagram 300, an input data set is received from a data source (bock 305). The data source may be any source of data known in the art. In one particular embodiment, the data source is a read channel of a hard disk drive system. Based upon the disclosure provided herein, one of ordinary skill in the art will recognize a variety of data sources from which data may be received in accordance with different embodiments of the present invention.

The received input data set is prepared for serial data transmission to yield a transmission data set (block 310). Preparing the input data set for transmission may include any processes known in the art for preparing a data set for serial data transmission. Such processes may include, but are not limited to, variable gain amplification and/or equalization. Either or both of the aforementioned variable gain amplification and equalization may be governed at least in part by a back channel feedback data set generated by a downstream circuit receiving and processing the transmission data set. The transmission data set is then transferred to a receiver (i.e., the downstream circuit receiving and processing the transmission data set) via a channel (block 315). Any process known in the art for transferring serial data from a transmission circuit to a receiver circuit via a channel may be used to effectuate the transfer.

At the receiver, analog processing is applied to the transmission data set to yield a processed analog input (block 320). The analog processing may include, but is not limited to, variable gain amplification. Based upon the disclosure provided herein, one of ordinary skill in the art will recognize a variety of analog processing that may be included as part of the aforementioned analog processing. The gain applied by the aforementioned variable gain amplification is governed by a gain control output.

Clock recovery processing is applied to the processed analog input to yield a data clock (block 325). The clock recovery processing may be done using any clock recovery circuit known in the art that is capable of recovering or generating a clock signal synchronous to a serial data stream. Based upon the disclosure provided herein, one of ordinary skill in the art will recognize a variety of clock recovery circuits that may be used in relation to different embodiments of the present invention.

A serial data recovery process is applied to the processed analog input synchronous to the data clock to yield a data output (block 330). The serial data recovery process may be done by a serial data recovery circuit that includes an equalizer circuit that equalizes the received data and provides the resulting equalized output as a serial data output. Equalizing the received data is controlled at least in part by an equalizer coefficient. Based upon the disclosure provided herein, one of ordinary skill in the art will recognize a variety of circuitry that may be included as part of the serial data recovery circuit. The resulting serial data output is provided to a downstream recipient (block 345).

A back channel feedback data set is calculated and provided as a feedback input to the transmission circuit (block 340). Any back channel feedback calculation approach known in the art may be used in relation to different embodiments of the present inventions. In some embodiments, the calculation is done using a least mean squared adaptation algorithm using an error value resulting from the serial data recovery process as is known in the art. The back channel feedback data set is the basis for back channel control and as such is generated to control one or more circuits included in an upstream data transmission circuit. Adaptation of the backchannel feedback data set is used to adjust equalization coefficients of an upstream serial data transmitter based on some parameters that are measured or sensed in a downstream data receiver. For example, where it is determined that the range of the equalization capability in the data receiver is insufficient, the back channel feedback data set is modified to increase the amount of equalization applied by the upstream serial data transmitter. As another example, when the channel between the serial data transmitter and the serial data receiver adds noise along with inter-symbol interference (ISI), the interim feedback data set may provide control to the serial data transmitter to boost the signal prior to transmission via the channel. Such an approach avoids boosting both signal and noise where the boost is applied in the serial data receiver instead of the upstream serial data transmitter. Such an approach may lead to an increase in signal to noise ratio of signals processed by the serial data receiver.

In addition, the equalizer coefficient used to in part control equalization in the receiving circuit and the gain control output used to control the variable gain applied in the receiving circuit are adapted to improve the quality of the serial data output (block 330). Any approach known in the art for adapting the gain control output and the equalizer coefficient may be used in relation to different embodiments of the present inventions. Such adaptation occasionally leads to a pair of an adapted equalizer coefficient and an adapted gain control output where the adapted equalizer coefficient is at a minimum leading to the possibility of over-equalization. Such a condition can result in too much relative boost (i.e., the difference between a low frequency gain controlled in part by the gain control output and a high frequency gain controlled in part by the equalizer coefficient). To mitigate this situation, over-equalization mitigation is applied.

Such over-equalization mitigation includes determining whether the adapted equalizer coefficient is at a minimum (block 350). The minimum is the lowest value which the equalizer coefficient is allowed to exhibit. Where the equalizer coefficient is not at a minimum (block 350), over-equalization mitigation is not applied. Where, on the other hand, the equalizer coefficient is at a minimum (block 350), it is determined whether the low frequency amplitude target is at a maximum (block 355). The low frequency amplitude target is an indirect representation of the value of the gain control output, and as such corresponds to the adapted value of the gain control output. Where the low frequency amplitude target is at a maximum (block 355), it is not possible to increase the low frequency amplitude target any farther in an effort to decrease the effective boost. Thus, over-equalization mitigation is not applied. On the other hand where the low frequency amplitude target is not at a maximum (block 355), it is possible to increase the low frequency amplitude target in an effort to decrease the effective boost. To do this, the low frequency amplitude target is incremented (block 360) and with the low frequency amplitude target updated the combination of the gain control output and the equalizer coefficient are re-equalized (block 335).

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent, albeit such a system would not be a circuit. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A data transfer system, the system comprising:
a receiver circuit operable to recover a data input from a data transfer set to yield a data output, wherein the receiver circuit includes:
a gain and equalization adaptation circuit operable to adaptively calculate an equalizer coefficient and a gain control; and
an over-equalization mitigation constraint circuit operable to increment the gain control to yield an updated gain control based at least in part on the equalizer coefficient
wherein the over-equalization mitigation constraint circuit is operable to increment the gain control to yield an updated gain control when the equalization coefficient is greater than a minimum allowable value and the gain control is below a maximum allowable value.

2. The data transfer system of claim 1, wherein the system further comprises:
a transmission circuit operable to prepare the data input for transmission to the receiver circuit.

3. The data transfer system of claim 2, wherein the receiver circuit further comprises:
a serial data recovery circuit including an equalizer circuit operable to equalize an input set derived from the data transfer set to yield the date input; and
wherein operation of the equalizer circuit is governed at least in part based upon the equalizer coefficient.

4. The data transfer system of claim 3, wherein the receiver circuit further comprises:
an analog front end circuit including a variable gain amplifier operable to amplify an analog signal derived from the data transfer set to yield an amplified output;
wherein operation of the variable gain amplifier is governed at least in part based upon the gain control; and
wherein the input set is derived from the amplified output.

5. The data transfer system of claim 1, wherein the over-equalization mitigation constraint circuit does not increment the gain control to yield the updated gain control when the equalization coefficient is less than the minimum allowable value and the gain control is greater than the maximum allowable value.

6. The data transfer system of claim 1, further comprising:
an analog front end circuit including a variable gain amplifier operable to amplify an analog signal derived from the data transfer set to yield an amplified output, wherein the gain control is a gain target for the amplified output.

7. The data transfer system of claim 1, wherein the over-equalization mitigation constraint circuit includes a comparator operable to compare the equalizer coefficient with a coefficient threshold to yield a coefficient status, and wherein the gain control is incremented based at least in part on the coefficient status.

8. The data transfer system of claim 7, wherein the comparator is a first comparator, and wherein the over-equalization mitigation constraint circuit further includes a second comparator operable to compare the gain control with a gain threshold to yield a gain status, and wherein the gain control is incremented based upon a combination of the coefficient status and the gain status.

9. The data transfer system of claim 1, wherein the gain control is a low frequency gain target, and wherein the receiver circuit further comprises:
a back channel feedback circuit operable to generate a back channel feedback data set based at least in part on one or both of the equalizer coefficient and the low frequency gain target.

10. The data transfer system of claim 9, wherein the system further comprises:
a transmission circuit operable to prepare the data input for transmission based at least in part on the back channel feedback data set to yield a data transfer set.

11. A method for data transmission, the method comprising:
receiving a data transfer set by a receiver circuit;
using a variable gain amplifier circuit to amplify a first data input derived from the data transfer set to yield an amplified output, wherein amplification by the variable gain amplifier circuit is governed at least in part based upon a gain control;
using an equalizer circuit to equalize a second data input derived from the first data input to yield an equalized output, wherein equalization by the equalizer circuit is governed at least in part based upon an equalizer coefficient; and
adaptively modifying at least one of the equalizer coefficient and the gain control based at least in part on an error value,
wherein adaptively modifying the at least one of the equalizer coefficient and the gain control based at least in part on the error value includes incrementing the gain control when the equalizer coefficient is greater than a minimum allowable value and the gain control is less than a maximum allowable value.

12. The method of claim 11, wherein the gain control is not incremented when the equalizer coefficient is greater than the minimum allowable value and the gain control is greater than the maximum allowable value.

13. The method of claim 11, wherein the method further comprises:
preparing the data input in a transmission circuit for transmission to the receiver device via a medium.

14. The method of claim 13, wherein the method further comprises:
generating a back channel feedback data set in the receiver circuit based at least in part on one or both of the equalizer coefficient and the gain control low; and
communicating the back channel feedback data set to the transmission circuit, wherein preparing the data input for transmission is governed at least in part based upon the back channel feedback data set.

15. The method of claim 11, wherein the method further comprises:
comparing the equalizer coefficient with a coefficient threshold to yield a coefficient status; and
wherein the gain control is incremented based at least in part on the coefficient status.

16. The method of claim 15, wherein the method further comprises:
comparing the gain control with a gain threshold to yield a gain status; and
wherein the gain control is incremented based upon a combination of the coefficient status and the gain status.

17. The method of claim 16, wherein the gain control is incremented when the coefficient status indicates that the equalizer coefficient is not greater than the coefficient threshold and the gain status indicates that the gain control is less than the gain threshold.

18. A storage device, the storage device comprising:
a receiver circuit operable to recover a data input from a data transfer set to yield a data output, wherein the receiver circuit includes:
a gain and equalization adaptation circuit operable to adaptively calculate an equalizer coefficient and a gain control;
an over-equalization mitigation constraint circuit operable to increment the gain control to yield an updated gain control based at least in part on the equalizer coefficient; and
a serial data recovery circuit including an equalizer circuit operable to equalize an input set derived from the data transfer set to yield the data input, wherein operation of the equalizer circuit is governed at least in part based upon the equalizer coefficient; and
a transmission circuit operable to prepare the data input for transmission to the receiver circuit,
wherein the over-equalization mitigation constraint circuit is operable to increment the gain control to yield the updated gain control when the equalization coefficient is greater than the minimum allowable value and the gain control less than a maximum allowable value.

19. The storage device of claim 18, wherein the receiver circuit further comprises:
an analog front end circuit including a variable gain amplifier operable to amplify an analog signal derived from the data transfer set to yield an amplified output;
wherein operation of the variable gain amplifier is governed at least in part based upon the gain control; and
wherein the input set is derived from the amplified output.

20. The storage device of claim 18, wherein the over-equalization mitigation constraint circuit does not increment the gain control to yield the updated gain control when the equalization coefficient is greater than the minimum allowable value and the gain control is greater than the maximum allowable value.
